(19) United States
(12) Patent Application Publication
(10) Pub. No.: US 2013/0050105 A1
(43) Pub. Date: Feb. 28, 2013

(54) TOUCH PANEL

(71) Applicants: Ji Soo Lee, Gyunggi-do (KR); Hyung Ho Kim, Gyunggi-do (KR); Sang Hwan Oh, Gyunggi-do (KR); Ho Joon Park, Seoul (KR)

(72) Inventors: Ji Soo Lee, Gyunggi-do (KR); Hyung Ho Kim, Gyunggi-do (KR); Sang Hwan Oh, Gyunggi-do (KR); Ho Joon Park, Seoul (KR)

(73) Assignee: SAMSUNG ELECTRO-MECHANICS CO., LTD., Gyunggi-do (KR)

(21) Appl. No.: 13/349,853

(22) Filed: Jan. 13, 2012

(30) Foreign Application Priority Data
Aug. 23, 2011 (KR) 1020110084041

(51) Int. Cl. G06F 3/041

(52) U.S. Cl. 345/173

(57) ABSTRACT

Disclosed herein is a touch panel. The touch panel 100 according to the present invention includes a transparent substrate 110 and sensing electrodes 120 formed on the transparent substrate 110, the sensing electrode being formed in a fine pattern including a combination of straight line patterns 123 and curved line patterns 125. The sensing electrode 120 is formed in the fine pattern including the combination of the straight line patterns 123 and the curved line patterns 125, thereby making it possible to prevent a Moire phenomenon from occurring and thus to improve visibility of the touch panel 100.

### CROSS REFERENCE TO RELATED APPLICATION

This application claims the benefit of Korean Patent Application No. 10-2011-0084041, filed on Aug. 23, 2011, entitled “Touch Panel”, which is hereby incorporated by reference in its entirety into this application.

### BACKGROUND OF THE INVENTION

1. Technical Field

The present invention relates to a touch panel.

2. Description of the Related Art

Alongside the growth of computers using digital technology, devices assisting computers have also been developed, and personal computers, portable transmitters and other personal information processors execute processing of text and graphics using a variety of input devices such as a keyboard and a mouse.

While the rapid advancement of the information-based society has been widening the use of computers more and more, there have been occurring the problems of it being difficult to efficiently operate products using only the keyboard and mouse as being currently responsible for the input device function. Thus, the demand for a device that is simple, has minimum malfunction, and has the capability to easily input information is increasing.

Furthermore, current techniques for input devices exceed the level of fulfilling general functions and thus are progressing towards techniques related to high reliability, durability, innovation, designing and manufacturing. To this end, a touch panel has been developed as an input device capable of inputting information such as text and graphics.

The touch panel is mounted on the display surface of an image display device such as an electronic organizer, a flat panel display including a liquid crystal display (LCD) device, a plasma display panel (PDP), an electroluminescence (El) element or the like, or a cathode ray tube (CRT), so that a user selects the information desired while viewing the image display device.

The touch panel is classifiable as a resistive type, a capacitive type, an electromagnetic type, a surface acoustic wave (SAW) type, and an infrared type. The type of touch panel selected is one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch panel. Currently, resistive and capacitive types are prevalently used in a broad range of fields.

In the touch panel according to the prior art, a sensing electrode is generally formed of indium tin oxide (ITO). ITO has excellent electric conductivity, but a raw material thereof, that is, indium is a rare earth metal and thus expensive, and besides, it is expected to run out in 10 years and therefore, supply and demand thereof will not be smooth.

For this reason, studies for forming a sensing electrode using a metal have actively progressed. The sensing electrode made of a metal has more excellent electric conductivity and more smooth supply and demand, as compared with the ITO. However, a problem arises in transparency of the touch panel due to the opaque characteristics of the metal. Therefore, there has been proposed a method of solving the problematic transparency of the touch panel by forming the sensing electrode made of a metal and having a fine pattern. However, the pattern according to the prior art has a lattice shape having regular and uniform intervals to cause a Moire phenomenon, thereby degrading visibility of the touch panel.

### SUMMARY OF THE INVENTION

The present invention has been made in an effort to provide a touch panel in which a sensing electrode is formed in a fine pattern including a combination of straight line patterns and curved line patterns to thereby prevent a Moire phenomenon from occurring.

According to a preferred embodiment of the present invention, there is provided a touch panel including: a transparent substrate; and sensing electrodes formed on the transparent substrate, the sensing electrode being formed in a fine pattern including a combination of straight line patterns and curved line patterns.

A distal end portion of the straight line pattern may be connected to a distal end portion of the curved line pattern.

The curved line pattern may have a shape of a periodic function.

The curved line pattern may have shapes of at least two periodic functions having different periods.

The curved line pattern may have shapes of at least two periodic functions having different amplitudes.

The straight line patterns may be disposed to be in parallel with each other from one side of the transparent substrate to the other side thereof.

The curved line pattern may be disposed between the two straight line patterns adjacent to each other so that the straight line pattern and the curved line pattern are spaced apart from each other.

The straight line pattern and the curved line pattern may be intersected with each other.

The touch panel may further include electrode wirings connected to distal end portions of the sensing electrodes.

The sensing electrode may be formed integrally with the electrode wiring.

The sensing electrode may be made of copper (Cu), aluminum (Al), gold (Au), silver (Ag), titanium (Ti), palladium (Pd), chrome (Cr), or a combination thereof.

### BRIEF DESCRIPTION OF THE DRAWINGS

FIGS. 1 to 4 are plan views of a touch panel according to a preferred embodiment of the present invention;

FIG. 5 is a cross-sectional view of the touch panel according to the preferred embodiment of the present invention; and

FIGS. 6 and 7 are cross-sectional views of touch panels manufactured using the preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, and so on are used to distinguish one element from another element, and the elements are not defined by the above terms. Further, in describing the present invention, a detailed description of related known functions or configurations will be omitted so as not to obscure the subject of the present invention.

Hereinafter, a preferred embodiment of the present invention will be described in detail with reference to the accompanying drawings.

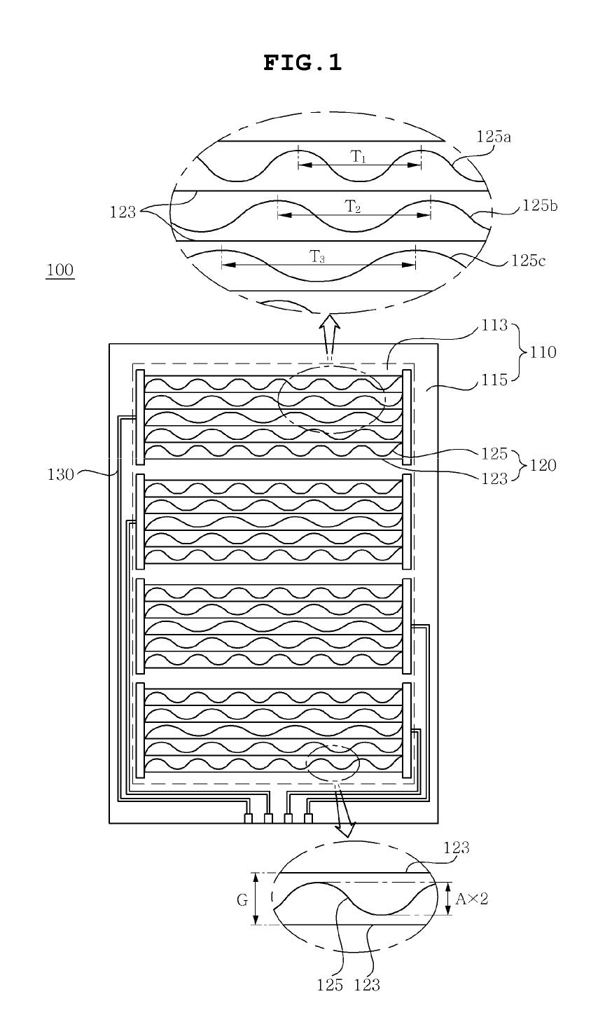

FIGS. 1 to 4 are plan views of a touch panel according to a preferred embodiment of the present invention.

As shown in FIGS. 1 to 4, the touch panel 100 according to the present embodiment is configured to include a transparent substrate 110 and sensing electrodes 120 formed on the transparent substrate 110, the sensing electrode 120 being formed in a fine pattern including a combination of straight line patterns 123 and curved line patterns 125.

The transparent substrate 110 serves to provide an area where the sensing electrodes 120 and electrode wirings 130 are formed. Herein, the transparent substrate 110 is partitioned into an active area 113 and a bezel area 115, wherein the active area 113 is provided at a central portion of the transparent substrate 110, the active area 113 having the sensing electrodes 120 formed thereon so as to recognize a touch of an input unit, and the bezel area 115 is provided at an edge of the active area 113 so as to enclose the active area 113, the bezel area 115 having the electrode wirings 130 formed thereon and connected to the sensing electrodes 120. In this configuration, the transparent substrate 110 is required to have supporting force to support the sensing electrodes 120 and the electrode wirings 130 and transparency to allow a user to recognize an image provided from an image display device. In consideration of the supporting force and transparency, the material of the transparent substrate 110 may include polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, polyimide (PI) film, polystyrene (PS), biaxially oriented polystyrene (BOPS; containing K resin), glass or tempered glass, and so on, but is not particularly limited thereto.

The sensing electrode 120 serves to sense a change in capacitance at the time of a touch of the input unit to allow a controller to recognize touched coordinates, and is formed on the active area 113 of the transparent substrate 110. Herein, the sensing electrode 120 may be formed using copper (Cu), aluminum (Al), gold (Au), silver (Ag), titanium (Ti), palladium (Pd), chrome (Cr), or a combination thereof. The sensing electrode 120 is preferably formed using copper (Cu), aluminum (Al), gold (Au), and silver (Ag) having high electric conductivity, however, a material of the sensing electrode 120 is not limited to the metals but may use all metals having high electric conductivity and being easily processed. Among others, when the sensing electrode 120 is formed using copper (cu), black oxide may be performed on the surface of the sensing electrode 120. The black oxide means a process of oxidizing a surface of the sensing electrode 120 to thereby precipitate Cu₂O or CuO. The surface of the sensing electrode 120 is subjected to the black oxide, thereby making it possible to prevent light from being reflected on the sensing electrode 120 and thus to improve visibility of the touch panel 100. Meanwhile, the sensing electrode 120 has generally a rod shape in view of the drawings, but is not limited thereto and may have all shapes publicly known in this field, such as a diamond shape, a rectangular shape, a triangular shape, a circular shape, and the like.

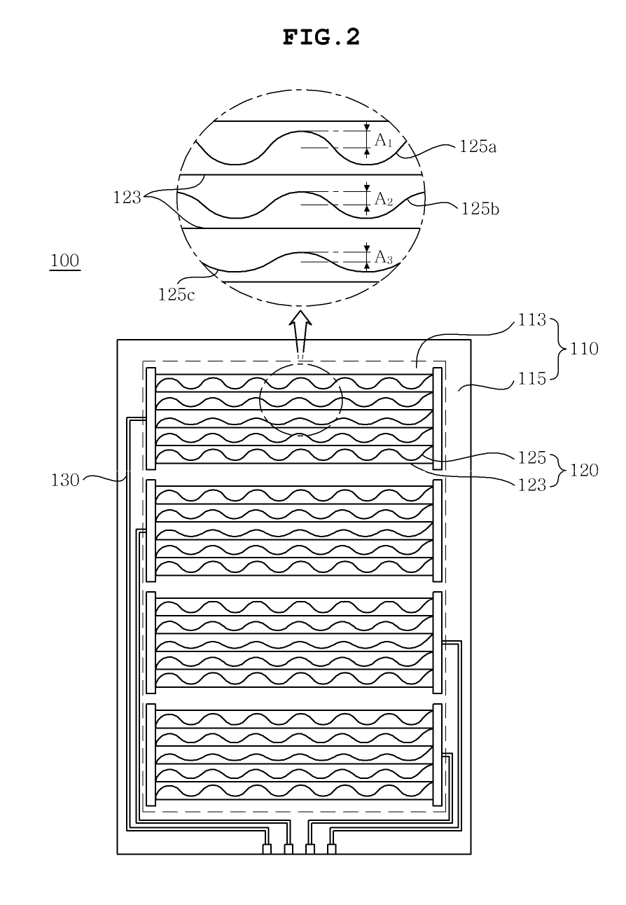

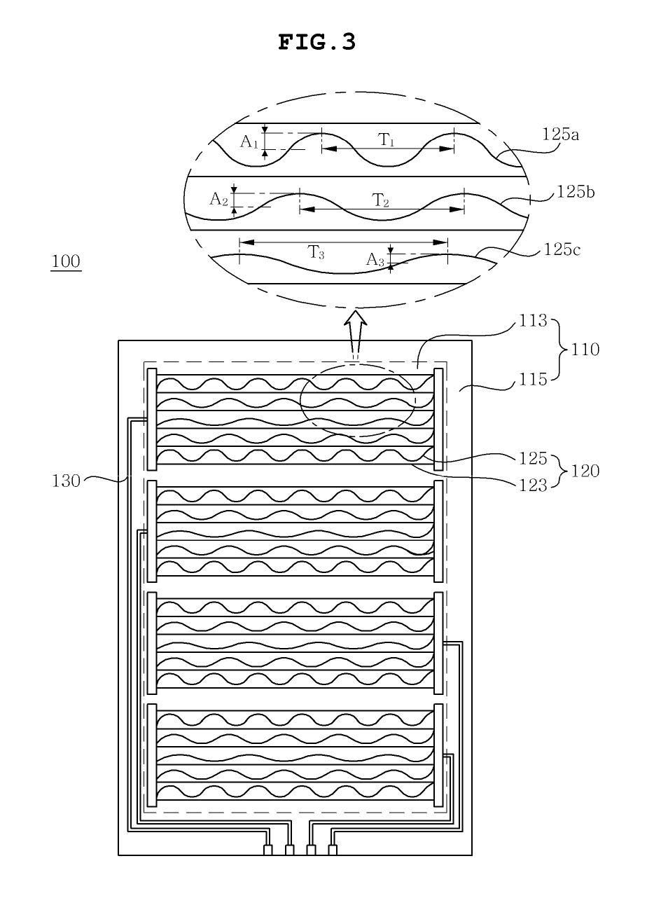

In addition, the sensing electrode 120 is formed in the fine pattern including a combination of the straight line patterns 123 and the curved line patterns 125. Herein, a distal end portion of the straight line pattern 123 and a distal end portion of the curved line pattern 125 are connected to each other to be finally connected to the electrode wiring 130. Meanwhile, the straight line patterns 123 and the curved line patterns 125 may be irregularly formed in order to prevent a Moire phenomenon from occurring. In detail, the curved line pattern 125 basically has a periodic function shape such as a sinusoidal wave, or the like. In more detail, the curved line pattern 125 may have shapes of at least two periodic functions having different periods. As shown in FIG. 1, for example, when a period of a first curved line pattern 125a is T₁, a period of a second curved line pattern 125b is T₂, and a period of a third curved line pattern 125c is T₃, the periods T₁, T₂, and T₃ are different from each other. As shown in FIG. 2, the curved line pattern 125 may also have shapes of at least two periodic functions having different amplitudes. For example, when an amplitude of the first curved line pattern 125a is A₁, an amplitude of the second curved line pattern 125b is A₂, and an amplitude of the third curved line pattern 125c is A₃, the amplitudes A₁, A₂, and A₃ are different from each other. As shown in FIG. 3, the curved line pattern 125 may also have shapes of at least two periodic functions having different periods and amplitudes. For example, when the period of the first curved line pattern 125a is T₁ and the amplitude thereof is A₁, the period of the second curved line pattern 125b is T₂ and the amplitude thereof is A₂, and the period of the third curved line pattern 125c is T₃ and the amplitude thereof is A₃, the periods T₁, T₂, and T₃ are different from each other and the amplitudes A₁, A₂, and A₃ are different from each other. As described above, the curved line patterns 125 are irregularly formed by using the combination of the shape of the periodic functions having different periods and amplitudes, thereby making it possible to prevent a Moire phenomenon from occurring in the lattice shape having uniform intervals.

Meanwhile, the straight line patterns 123 of the fine pattern may be disposed to be in parallel with each other from one side of the transparent substrate 110 to the other side thereof. In this configuration, as shown in FIG. 1, the amplitude X2(AX2) of the curved line pattern 125 may be formed to be smaller than the interval (G) of the two straight line patterns 123 adjacent to each other to thereby dispose the curved line pattern 125 between the two straight line patterns 123 adjacent to each other, in order that the curved line pattern 125 and the straight line pattern 123 are spaced apart from each other. In this case, a distance from the touched point to the electrode wiring 130 in the straight line pattern 123 is shorter than that in the curved line pattern 125. Therefore, the straight line pattern 123 may be used as a main unit sensing a touch of an input unit, and the curved line pattern 125 may be used as an auxiliary unit assisting the straight line pattern 123 by widening a contact area of the touch of the input unit.

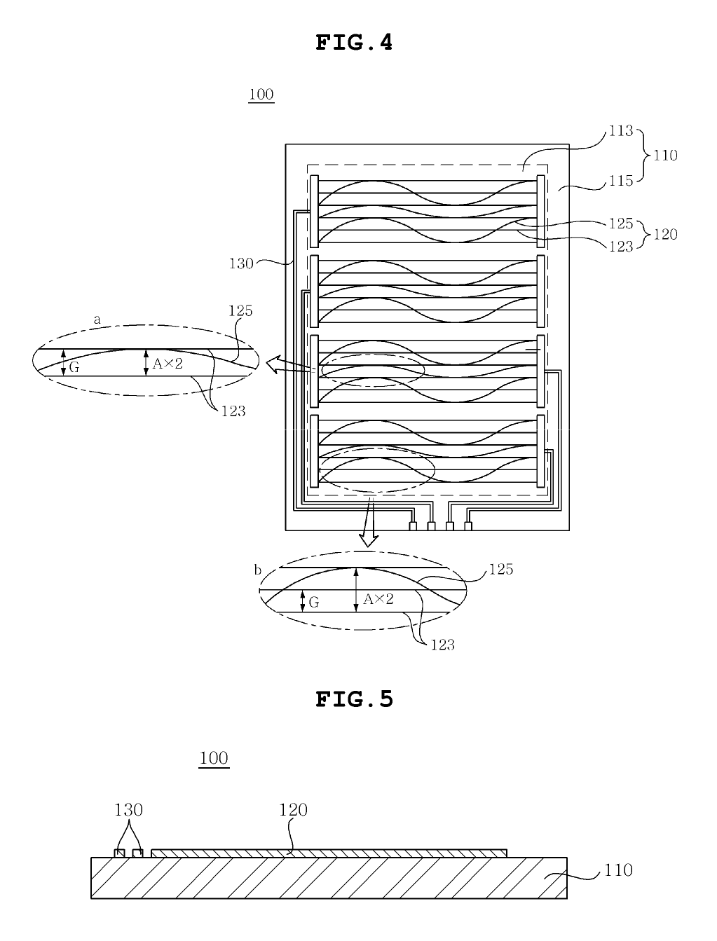

The straight line pattern 123 and the curved line pattern 125 are not always spaced apart from each other but may be intersected with each other, as shown in FIG. 4. Herein, the amplitude X2(AX2) of the curved line pattern 125 may be formed to be equal to (see part a) or larger than (see part b) the interval (G) of the two straight line patterns 123 adjacent to each other, in order that the curved line pattern 125 and the straight line pattern 123 are intersected with each other. In this case, the straight line pattern 123 and the curved line pattern 125 are connected to each other, whereby the sensing electrode 120 can continuously sense the touch of the input unit even though a disconnection occurs in any one of the straight line pattern 123 and the curved line pattern 125.

In addition, the electrode wiring 130 may be formed in the bezel area 115 of the transparent substrate 110 so as to be connected to the distal end portion of the sensing electrode 120. Herein, the electrode wiring 130 is connected to the sensing electrode 120 to thereby receive an electrical signal from the sensing electrode 120. Herein, the electrode wiring 130 may preferably be made of silver (Ag) having high electric conductivity. However, the electrode wiring 130 may be formed using copper (Cu), gold (Au), aluminum (Al), or the like, without being limited thereto. Further, the electrode wiring 130 is formed integrally with the sensing electrode 120, as needed, thereby making it possible to simplify a manufacturing process of the touch panel 100 and shorten a lead time. In addition, the electrode wiring 130 is formed integrally with the sensing electrode 120 simultaneously with forming the sensing electrode 120, thereby making it possible to omit a bonding process between the electrode wiring 130 and the sensing electrode 120 and thus to prevent steps or bonding defects between the sensing electrode 120 and the electrode wiring 130 from occurring.

Meanwhile, FIG. 5 is a cross-sectional view of the touch panel according to the preferred embodiment of the present invention.

As shown in FIG. 5, in the touch panel 100 according to the present embodiment, a capacitive type touch panel may be manufactured using the sensing electrode 120 having a single layer structure. However, the touch panel according to the present invention is not limited thereto but various types of touch panels 200 and 300 having the configuration may be manufactured, as described below.

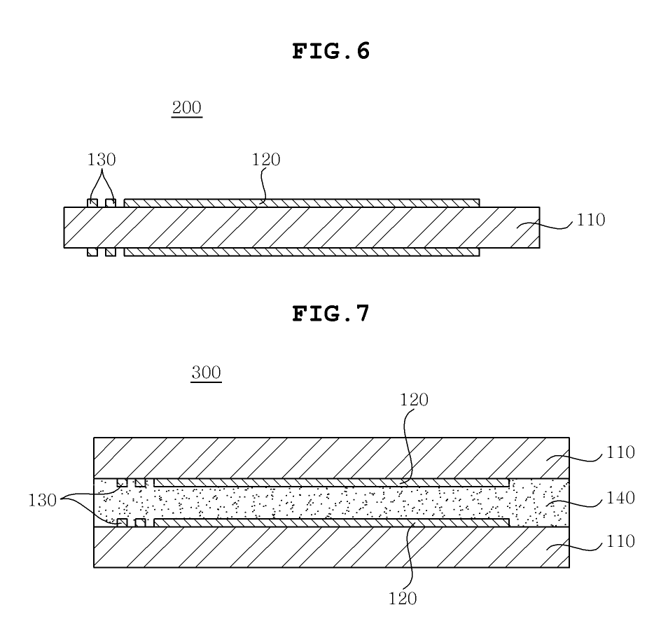

FIGS. 6 and 7 are cross-sectional views of touch panels manufactured using the preferred embodiment of the present invention.

As shown in FIG. 6, a touch panel 200 may be manufactured by forming sensing electrodes 120 on both surfaces of a transparent substrate 110, respectively. Alternatively, as shown in FIG. 7, a touch panel 300 may be formed by preparing two transparent substrates 110 having sensing electrodes 120 formed on one surface thereof and bonding the two transparent substrates 110 using an adhesive layer 140 so that the sensing electrodes 120 face each other. In this case, the adhesive layer 140 is attached to a front surface of the transparent substrate 110 so that the two facing sensing electrodes 120 are insulated from each other.

In the touch panels 200 and 300 manufactured using the preferred embodiment of the present invention, the sensing electrode 120 is also formed in the fine pattern including the combination of the straight line patterns 123 and the curved line patterns 125 to prevent a Moire phenomenon from occurring, whereby visibility of the touch panels 200 and 300 may be improved.

As set forth above, according to the preferred embodiment of the present invention, the sensing electrode is formed in the fine pattern including the combination of the straight line patterns and the curved line patterns, thereby making it possible to prevent the Moire phenomenon from occurring and thus improve visibility of the touch panel.

Although the preferred embodiments of the present invention have been disclosed for illustrative purposes, they are for specifically explaining the present invention and thus a touch panel according to the present invention is not limited thereto, but those skilled in the art will appreciate that various modifications, additions and substitutions are possible, without departing from the scope and spirit of the invention as disclosed in the accompanying claims. Accordingly, any and all modifications, variations or equivalent arrangements should be considered to be within the scope of the invention, and the detailed scope of the invention will be disclosed by the accompanying claims.

What is claimed is:

1. A touch panel comprising:
a transparent substrate; and
sensing electrodes formed on the transparent substrate, the sensing electrode being formed in a fine pattern including a combination of straight line patterns and curved line patterns.

2. The touch panel as set forth in claim 1, wherein a distal end portion of the straight line pattern is connected to a distal end portion of the curved line pattern.

3. The touch panel as set forth in claim 1, wherein the curved line pattern has a shape of a periodic function.

4. The touch panel as set forth in claim 3, wherein the curved line pattern has shapes of at least two periodic functions having different periods.

5. The touch panel as set forth in claim 3, wherein the curved line pattern has shapes of at least two periodic functions having different amplitudes.

6. The touch panel as set forth in claim 1, wherein the straight line patterns are disposed to be in parallel with each other from one side of the transparent substrate to the other side thereof.

7. The touch panel as set forth in claim 6, wherein the curved line pattern is disposed between the two straight line patterns adjacent to each other so that the straight line pattern and the curved line pattern are spaced apart from each other.

8. The touch panel as set forth in claim 6, wherein the straight line pattern and the curved line pattern are intersected with each other.

9. The touch panel as set forth in claim 1, further comprising electrode wirings connected to distal end portions of the sensing electrodes.

10. The touch panel as set forth in claim 9, wherein the sensing electrode is formed integrally with the electrode wiring.

11. The touch panel as set forth in claim 1, wherein the sensing electrode is made of copper (Cu), aluminum (Al), gold (Au), silver (Ag), titanium (Ti), palladium (Pd), chrome (Cr), or a combination thereof.
